(19) United States
(12) Patent Application Publication
(10) Pub. No.: US 2025/0023977 A1
(43) Pub. Date: Jan. 16, 2025

(54) Method of Managing Driving Mode

(71) Applicant: Media Tek Singapore Pte. Ltd., Singapore (SG)

(72) Inventors: Saurav Jha, Noida (IN); Shailendra Singh, Noida (IN); Pawanjeet Singh, Noida (IN); Sameer Sethi, Noida (IN)

(73) Assignee: Media Tek Singapore Pte. Ltd., Singapore (SG)

(21) Appl. No.: 18/429,365

(22) Filed: Jan. 31, 2024

(30) Foreign Application Priority Data
Jul. 14, 2023 (IN) 202321047512

(51) Int. Cl. H04M 1/72463; H04M 3/436

(52) U.S. Cl. CPC H04M 1/724634; H04M 3/436

(57) ABSTRACT

A method of managing a driving mode of a mobile device including sending a driving mode enabling request to a network by the mobile device, receiving a response in associate with the driving mode enabling request from the network, and enabling a driving mode according to the response. The response from the network includes an indication that the driving mode enabling request is granted.

### BACKGROUND

Driving mode is a feature that allows a user to use mobile device safely while driving. When driving mode is enabled, the mobile device would automatically mute incoming notifications, such as calls, messages, emails, and social media alerts. It may also send auto-replies to incoming calls and messages, letting the sender know that the user is driving and will get back to the caller later.

Also, driving mode may launch a simplified interface that lets the user access essential functions such as navigation, music, and voice control. The user can use voice commands to make calls, send messages, get directions, play music, and more. Thus, driving mode helps the user to stay focused on the road and avoid distractions from mobile device.

However, the existing solutions mostly function in the imposing manner so far as incoming calls are concerned. That is, it either automatically disconnects the incoming call or hides the incoming call from the user. As a result, there is a possibility that the user may miss an urgent call.

Although the current solutions include options for the user to allow calls to get through from allowed contacts, the execution of call intercepting starts when the call has already arrived to the mobile device.

It is important to propose a solution that functions in an advisory as well as pro-active manner by informing the caller concerning the user's driving status to allow the caller to make an informed decision.

### SUMMARY

An embodiment provides a method of managing a driving mode of a mobile device. The method includes sending a driving mode enabling request to a network by the mobile device, receiving a response in associate with the driving mode enabling request from the network, and enabling a driving mode according to the response. The response from the network includes an indication that the driving mode enabling request is granted.

An embodiment provides an operator network including a status server and a core network coupled to the status server. The status server is used to store a driving mode of a first mobile device. The core network is used to enable the driving mode of the first mobile device when receiving a driving mode enabling request, and generate a response to indicate that the driving mode has been enabled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a scenario of a subscriber and a caller communicating via a network of an embodiment.

FIG. 2 depicts a session sequence diagram for the method of calling between the subscriber and the caller via the network of an embodiment.

FIG. 3 depicts a session sequence diagram for the method of calling between the subscriber and the caller via the network of another embodiment.

FIG. 4 depicts an operation in the activation stage of an embodiment.

FIG. 5 depicts an operation in the execution stage of an embodiment.

FIG. 6 depicts an operation in the deactivation stage of an embodiment.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context of interworking between a 3GPP specified wireless network (e.g., 4G and 5G) and an IEEE 802.11 specified wireless network (e.g., Wi-Fi), but it can be implemented in other forms of cellular or non-cellular wireless networks as well.

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi).

The following technique, apparatus and system can be applied to various wireless multiple access systems. Examples of multiple access systems include a Code Division Multiple Access (CDMA) system, a Frequency Division Multiple Access (FDMA) system, a Time Division Multiple Access s (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRA (E-UTRA). UTRA is part of Universal Mobile the Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, the implementation of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

As described by the 3GPP, different wireless communication systems standards and protocols can use various radio access networks (RANs) for communicating between a base station of the RAN (which may sometimes be referred to generally as a RAN node, a network node, or simply a node) and a wireless communication device known as user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

The term “operator network” or “network” used in this disclosure may refer the infrastructure, software and hardware enabling wireless communications between and among subscribers and third parties.

The term “core network” as used in this disclosure may refer to a network that provides various services and functions to the wireless access network and the user equipment. The core network may include components such as mobility management entities, serving gateways, packet data network gateways, home subscriber servers, policy and charging rules functions, and authentication, authorization and accounting servers. The core network may support different radio access technologies, such as 4G, 5G, Wi-Fi, and satellite, and enable handover and interoperability among them.

For terms and techniques not specifically described, reference may be made to wireless communication standard documents (e.g., 3GPP Specifications, RFC Memos) issued before this specification.

In this specification, technical features that are individually described within one drawing may be implemented individually or simultaneously.

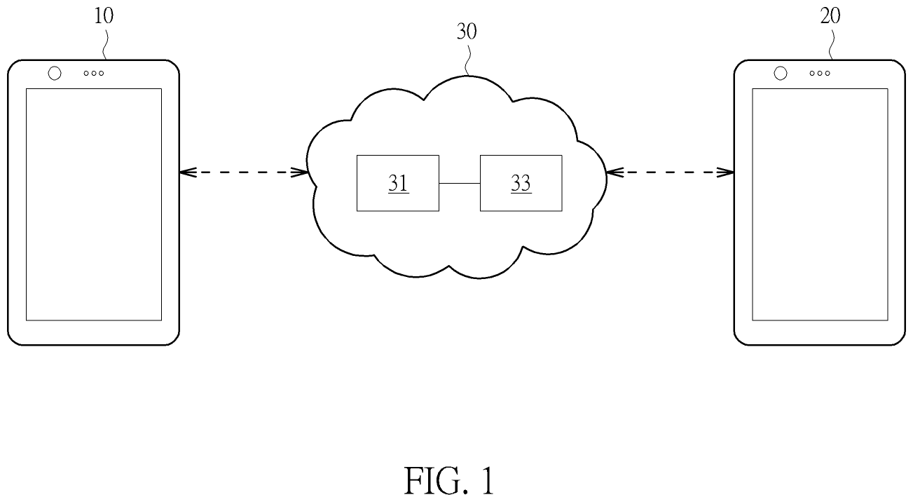

FIG. 1 depicts a scenario of a subscriber 10 and a caller 20 communicating via a network 30 of an embodiment of the present invention. The network 30 includes a core network 33 and a status server 31. The status server 31 is used to store a driving mode status of a subscriber. The core network 33 is used to update the driving mode status of the subscriber when receiving a driving mode status update request and generate a response indicating the driving mode has been enabled or disabled.

As used herein in this disclosure, the subscriber 10 and the caller 20 each may represent (or be associated with) a mobile device. In other words, the subscriber 10 may be associated with a first mobile device, and the caller 20 may be associated with a second mobile device.

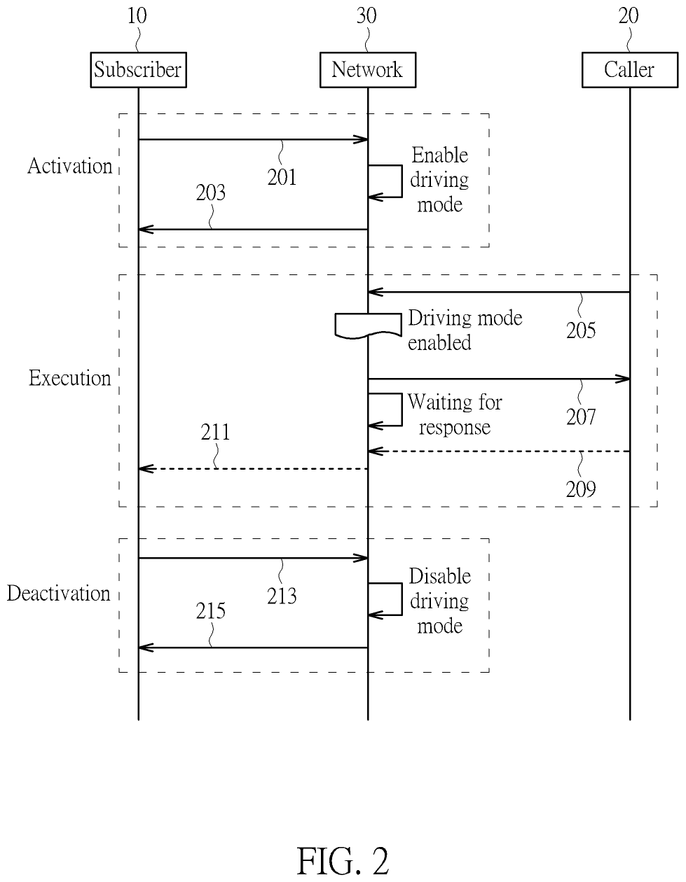

FIG. 2 depicts a session sequence diagram for the method of calling between the subscriber 10 and the caller 20 via the network 30 of an embodiment. In the activation stage, initially, the subscriber 10 may send a driving mode enabling request 201 to the network 30. The network 30 may enable the driving mode of the subscriber 10 when receiving the driving mode enabling request 201. This may be carried out by updating the driving mode status of the subscriber 10 in the status server 31. Then, the network 30 may send a response 203 to the subscriber 10 to indicate the driving mode has been enabled.

In the execution stage, the caller 20 may send a call request 205 to the subscriber 10 via the network 30. At this time, the network 30 may find that the driving mode is enabled for the subscriber 10. Then, the network 30 may send a message 207 to convey to the caller 20 that the driving mode of the subscriber 10 has been enabled. In some embodiments, the caller 20 may receive a voice message conveying that the subscriber 10 is driving. In some embodiments, the caller 20 may receive a text message or notification conveying that the subscriber 10 is driving.

At this time, the caller 20, knowing that the subscriber 10 is driving, may be prompted with a question asking whether to connect the call. If the caller 20 decides to connect the call, the caller 20 may send a call connect inquiry 209 to the network 30. Then, the network 30 may send a call connect request 211 to the subscriber 10 when receiving the call connect inquiry 209. If the caller 20 decides not to connect the call, the caller 20 may send a call termination message to the network 30 to disconnect the call. Then, the network 30 may notify the subscriber 10 concerning a missed call with call details of the caller 20.

In the deactivation stage, the subscriber 10 may send driving mode disabling request 213 to a network 30. The network 30 may disable the driving mode of the subscriber 10 when receiving the driving mode disabling request 213. This may be carried out by updating the driving mode status of the subscriber 10 in the status server 31. Then, the network may send a response 215 to the subscriber 10 to indicate the driving mode has been disabled.

In some embodiments, the method described by FIG. 2 may be implemented with Session Initiation Protocol (SIP), Session Description Protocol (SDP) or the equivalent thereof.

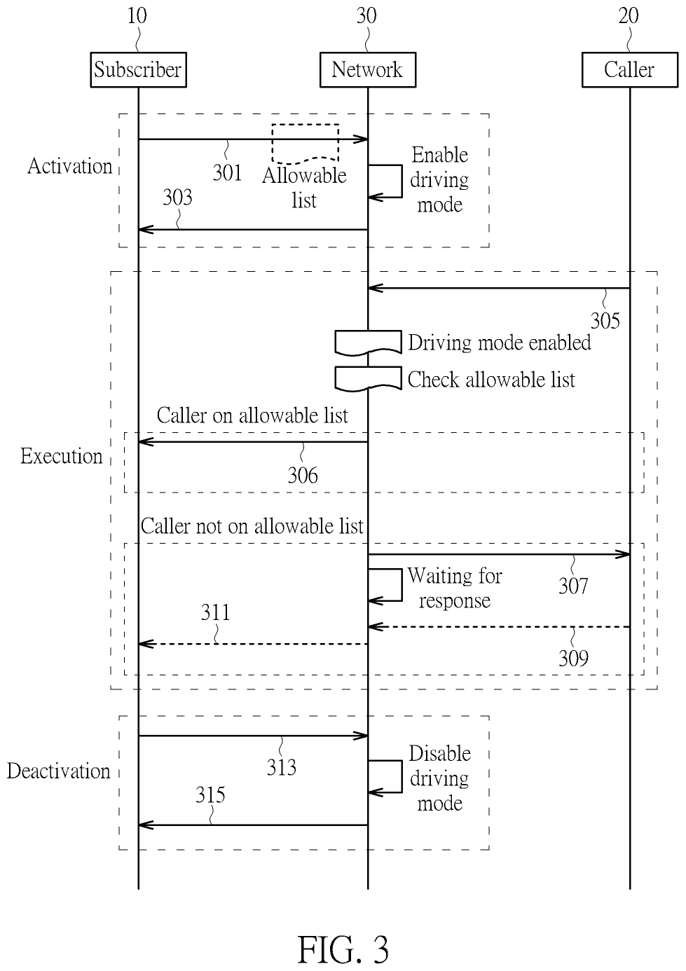

FIG. 3 depicts a session sequence diagram for the method of calling between the subscriber 10 and the caller 20 via the network 30 of another embodiment. In the activation stage, initially, the subscriber 10 may send a driving mode enabling request 201 with an allowable list to the network 30. The allowable list may contain contacts that may go through with normal calling procedure. That is, if the caller 20 is included on the allowable list, a call from the caller 20 may go through without being interrupted by the network 30.

The network 30 may enable the driving mode of the subscriber 10 when receiving the driving mode enabling request 301. This may be carried out by updating the driving mode status of the subscriber 10 in the status server 31. Then, the network 30 may send a response 303 to the subscriber 10 to indicate the driving mode has been enabled.

In the execution stage, the caller 20 may send a call request 305 to the subscriber 10 via the network 30. At this time, the network 30 may find that the driving mode is enabled for the subscriber 10. Then, the network 30 may check whether the caller 20 is on the allowable list. If the caller 20 is on the allowable list, the network 30 may send a call connect request 306 to the subscriber 10. If the caller 20 is not on the allowable list, the network may send a message 307 to convey to the caller 20 that the driving mode of the subscriber 10 has been enabled. In some embodiments, the caller 20 may receive a voice message conveying that the subscriber 10 is driving. In some embodiments, the caller 20 may receive a text message or notification conveying that the subscriber 10 is driving.

At this time, the caller 20, knowing that the subscriber 10 is driving, may be prompted with a question asking whether to connect the call. If the caller 20 decides to connect the call, the caller 20 may send a call connect inquiry 309 to the network 30. Then, the network 30 may send a call connect request 311 to the subscriber 10 when the receiving the call connect inquiry 309. If the caller 20 decides not to connect the call, the caller 20 may send a call termination message to the network 30 to disconnect the call. Then, the network 30 may notify the subscriber 10 concerning a missed call with call details of the caller 20.

In the deactivation stage, the subscriber 10 may send driving mode disabling request 313 to a network 30. The network 30 may disable the driving mode of the subscriber 10 when receiving the driving mode disabling request 313. This may be carried out by updating the driving mode status of the subscriber 10 in the status server 31. Then, the network 30 may send a response 315 to the subscriber 10 to indicate the driving mode has been disabled.

In some embodiments, the method described by FIG. 3 may be implemented with Session Initiation Protocol 1 (SIP), Session Description Protocol (SDP) or the equivalent thereof.

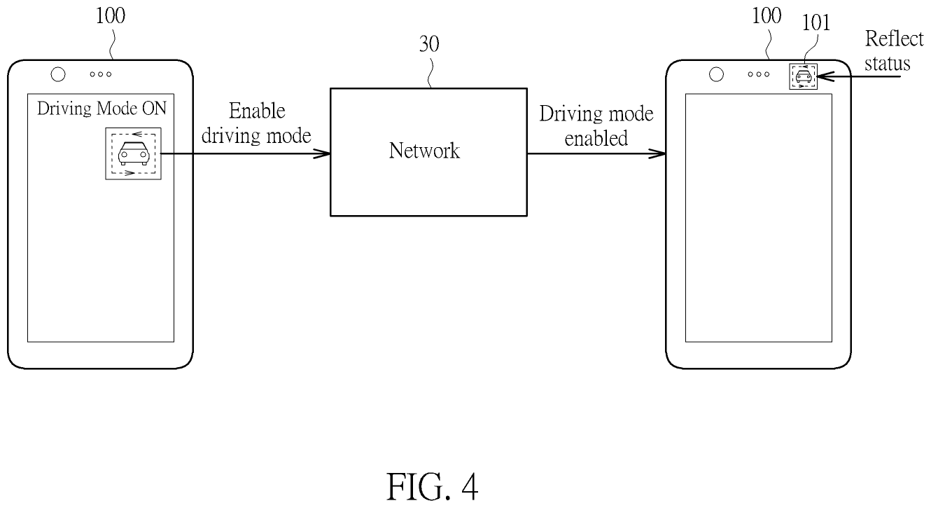

FIG. 4 depicts an operation in the activation stage of an embodiment. User equipment (UE) 100 may be associated with the subscriber 10 in FIG. 1. That is, the subscriber 10 (i.e., a user) may use the UE 100 for phone calls. The user operating the UE 100 may turn on the driving mode. The turning on option can be implemented by graphic user interface (GUI), Unstructured Supplementary Service Data (USSD) Code, and/or Short Message Service (SMS). Then, the UE 100 sends a driving mode enabling request to the network 30. Accordingly, the network 30 enables the driving mode of the subscriber 10. Then, the UE 100 may receive a message notifying that driving mode is enabled. Finally, “Driving Mode ON” status 101 can be displayed on the status bar of the UE 100.

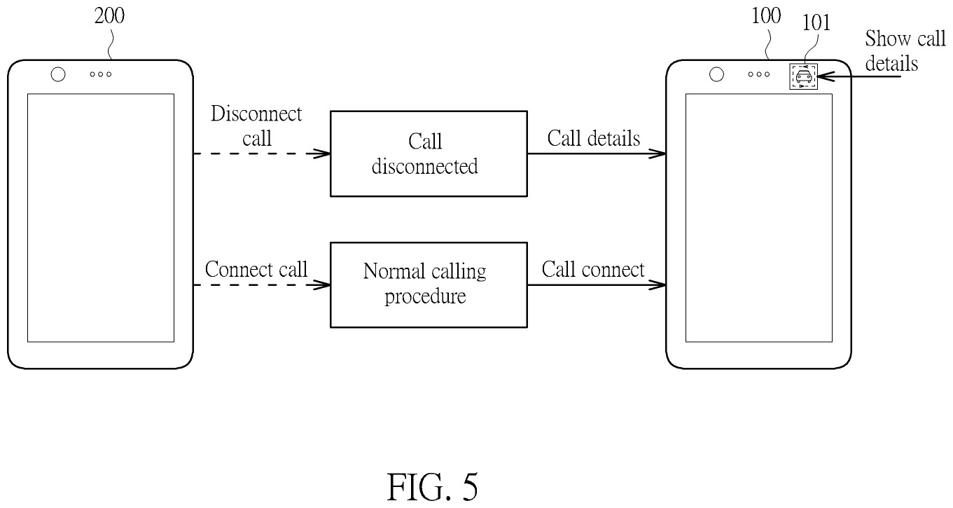

FIG. 5 depicts an operation in the execution stage of an embodiment. User equipment (UE) 200 may be associated with the caller 20 in FIG. 1. That is, the caller 20 (i.e., a user) may use UE 200 for phone calls. When a prompt shown on the UE 200 with a question asking whether to connect the call, a response from the caller 20 may be implicit or explicit.

In some embodiments, an implicit response can be time based, allowing the UE 200 a time interval to disconnect the call. If the call is not disconnected, a call connect inquiry would be sent to the network 30. On the other hand, an explicit response allows the UE 200 a time interval to trigger the call connect inquiry. That is, the UE 200 may prompt the caller 20 to press a specific key within a time interval (e.g., 5 seconds) if the caller wishes to connect the call.

Furthermore, if the call is disconnected, the network may send the call details to the UE 100, and the UE 100 may show the call detail on the status bar.

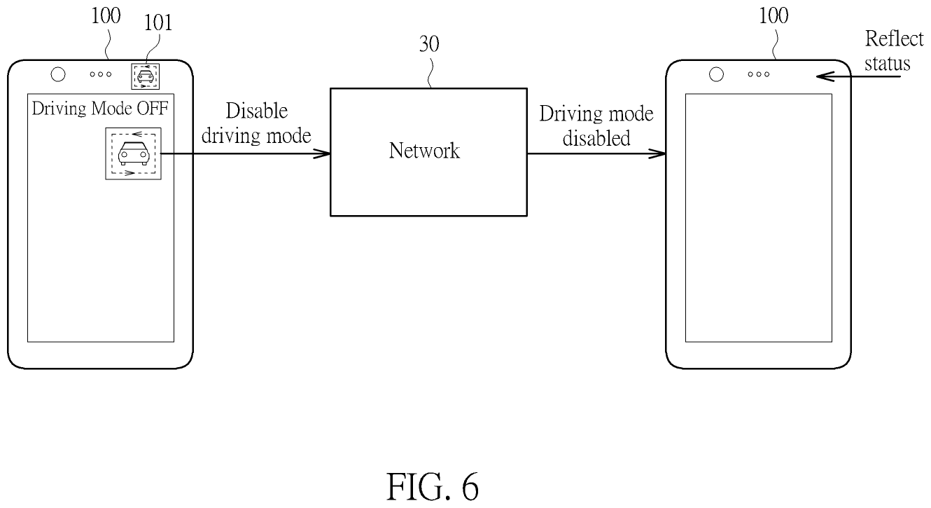

FIG. 6 depicts an operation in the deactivation stage of an embodiment. User equipment (UE) 100 may be associated with (or represent) the subscriber 10 in FIG. 1. A user may use UE 100 for phone calls. The user operating the UE 100 may turn off the driving mode. The turning off option can be implemented by graphic user interface (GUI), Unstructured Supplementary Service Data (USSD) Code, and/or Short Message Service (SMS). Then, the UE 100 sends a driving mode disabling request to the network 30. Accordingly, the network 30 disables the driving mode of the subscriber 10. Then, the UE 100 may receive a message notifying that driving mode is disabled. Finally, “Driving Mode ON” status 101 would disappear from the status bar of the UE 100.

The UE as described in this disclosure may include a device with radio communication capabilities (i.e., a mobile device). For example, the UE may include a smartphone (e.g., handheld touchscreen mobile computing devices connectable to one or more cellular networks). The UE may also include any mobile or non-mobile computing device, such as Personal Data Assistants (PDAs), pagers, laptop computers, desktop computers, wireless handsets, or any computing device that has a wireless communications interface.

The UE may also be referred to as a client, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE may include IoT UE, which can include a network access layer designed for low-power IoT applications utilizing short-lived UE connections. IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UE, which may include uniquely identifiable embedded computing devices (within the Internet infrastructure). The IoT UE may execute background applications (e.g., keep-alive messages, status updates, etc.) to facilitate the connections of the IoT network.

The terms “coupled”, “connected”, “connecting”, “electrically connected”, etc., are used interchangeably herein to generally refer to the condition of being electrically/electronically connected (through wire or wireless means). Similarly, a first entity is considered to be in “communication” or “connection” with a second entity (or entities) when the first entity electrically sends and/or receives (through wire or wireless means) information signals (containing voice information or non-voice data/control information) to/from the second entity regardless of the type (analog or digital) of those signals. It is further noted that various figures (including component diagrams) shown and discussed herein are for illustrative purpose only, and are not drawn to scale.

It is also noted that the operational steps described in any of the exemplary aspects herein are described to provide examples and discussion. The operations described may be performed in numerous different sequences other than illustrated the sequences. Furthermore, operations described in a single operational step may actually be performed in a number of different steps. Additionally, one or more operational steps discussed in the exemplary aspects may be combined. It is to be understood that the operational steps illustrated in the session sequence diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing a driving mode of a mobile device comprising:
sending a driving mode enabling request to a network by the mobile device;
receiving a response in associate with the driving mode enabling request from the network, and
enabling a driving mode according to the response, wherein the response from the network comprises an indication that the driving mode enabling request is granted.

2. The method of claim 1, wherein when the driving mode is enabled, the mobile device displays driving mode enabled status on a user interface of the mobile device.

3. The method of claim 2, wherein when the driving mode is enabled, the mobile device does not connect an incoming call.

4. The method of claim 1 further comprising:
sending a driving mode disabling request to the network by the mobile device after the driving mode is enabled;
receiving a response in associate with the driving mode disabling request from the network, and
disabling a driving mode according to the response, wherein the response from the network comprises an indication that the driving mode disabling request is granted.

5. The method of claim 1 further comprising sending an allowable list to the network.

6. An operator network comprising:
a status server configured to store a driving mode of a first mobile device; and
a core network coupled to the status server, configured to:
enable the driving mode of the first mobile device when receiving a driving mode enabling request; and
generate a response to indicate that the driving mode has been enabled.

7. The operator network of claim 6, wherein the core network is further configured to:
receive a call request from a second mobile device to the first mobile device; and
convey the driving mode of the first mobile device has been enabled to the second mobile device.

8. The operator network of claim 7, wherein the core network is further configured to:
receive a call connect inquiry from the second mobile device; and
send a call connect request to the first mobile device when receiving the call connect inquiry.

9. The operator network of claim 7, wherein the core network is further configured to receive a call termination message from the second mobile device.

10. The operator network of claim 7, wherein the core network is further configured to send call termination detail to the first mobile device.

11. The operator network of claim 6, wherein the core network is further configured to:
disable the driving mode of the mobile device when receiving a driving mode disabling request; and
generate a response to indicate the driving mode has been disabled.

12. The operator network of claim 6, wherein the core network is further configured to:
receive a call request from a second mobile device to the mobile device; and
send a call connect request to the mobile device if the second mobile device is in an allowable list.
